(19) United States
(12) Patent Application Publication
(10) Pub. No.: US 2023/0295544 A1
(43) Pub. Date: Sep. 21, 2023

(54) BREWING SYSTEM

(71) Applicant: Unique Bavarian Brewery, LLC, Castle Pines, CO (US)

(72) Inventors: Michael Anthony Lentz, Bangkok (TH); Wilhelm Trappe, Vienna (AT); Paramase Pholphanich, Nonthaburi (TH); Onnicha Boonsavapark, Pathum Thani (TH)

(21) Appl. No.: 18/186,924

(22) Filed: Mar. 20, 2023

Related U.S. Application Data
(60) Provisional application No. 63/321,479, filed on Mar. 18, 2022.

(51) Int. Cl. C12C 13/00; C12C 7/04; C12C 7/14; C12C 7/26; C12C 11/00

(52) U.S. Cl. CPC C12C 13/00; C12C 7/04; C12C 7/14; C12C 7/26; C12C 11/003

(57) ABSTRACT

Examples relating to a brewing system are provided. The brewing system includes an outer housing; a first tank and a second tank arranged within an interior region of the outer housing; a fluid coupling system arranged between the first tank and the second tank and fluidly coupling the first tank and the second tank; and an operator interface for controlling the operation of the brewing system. In another example, a method of brewing a beverage using a brewing system is provided. The method comprises: receiving, by the brewing system, an indication of a recipe via an operator interface; receiving ingredients; mashing the ingredients to form a mash; transporting the mash; lautering the ingredients to form a wort; cooling the wort; receiving an indication of whether to perform a fermentation of the wort or a transfer of the wort to a separate system; and cleaning the brew system.

### CROSS-REFERENCE TO RELATED APPLICATION

This application claims priority to U.S. Provisional Application No. 63/321,479, titled “Brewing System,” filed on Mar. 18, 2022, the entire disclosure of which is hereby incorporated by reference in its entirety.

### BACKGROUND

Brewing beverages, for example brewing beer, is typically a laborious process that requires several individually conducted steps and large equipment for conducting these steps. The brewing process may be composed of the steps of mashing a milled grain to create a mash, boiling the mash, lautering the mash to form wort and spent grains, clarifying the wort, and fermenting the resulting clarified wort. In typical brewing processes, the equipment required to accomplish these steps may be expensive and occupy a large floor space. The process may additionally require qualified brewing technicians and cleaning staff.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

In an example, a brewing system is provided. The brewing system includes an outer housing; a first tank and a second tank arranged within an interior region of the outer housing, the first tank defined by an inner cylinder and an outer cylinder, and the second tank defined by an inner cylinder and an outer cylinder; a fluid coupling system arranged between the first tank and the second tank and fluidly coupling the first tank and the second tank; and an operator interface for controlling the operation of the brewing system.

In another example, a method of brewing a beverage using a brewing system is provided. The brewing system includes a first tank positioned adjacent to and fluidly coupled with a second tank. The method comprises: receiving, by the brewing system, an indication of a recipe via an operator interface; receiving ingredients; mashing the ingredients to form a mash; transporting the mash; lautering the ingredients to form a wort; cooling the wort; receiving an indication of whether to perform a fermentation of the wort or a transfer of the wort to a separate system; and cleaning the brew system.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF FIGURES

Non-limiting and non-exhaustive examples are described with reference to the following Figures.

FIG. 1 illustrates a top perspective view of the brewing system which is defined by a generally rounded rectangular shape.

FIG. 2A illustrates a front facing schematic view of an exemplary brewing system.

FIG. 2B illustrates a side view of an exemplary brewing system.

FIG. 2C illustrates yet another top view of an exemplary brewing system.

FIG. 3 illustrates a perspective view of the brewing system including various of internal components of the brewing system.

FIG. 4 illustrates an exploded view of an exemplary brewing system.

FIG. 5 illustrates a perspective view of a portion of an outer housing of an exemplary brewing system.

FIG. 6 illustrates an exemplary portion of an outer housing with a window in an open position.

FIG. 7 illustrates an exemplary method of brewing a liquid.

### DETAILED DESCRIPTION

Various aspects of the disclosure are described more fully below with reference to the accompanying drawings, which forms a part hereof, and which show specific example aspects. However, different aspects of the disclosure may be implemented in many different ways should not be construed as limited to the aspects set forth herein. The following detailed description is, therefore, not to be taken in a limiting sense.

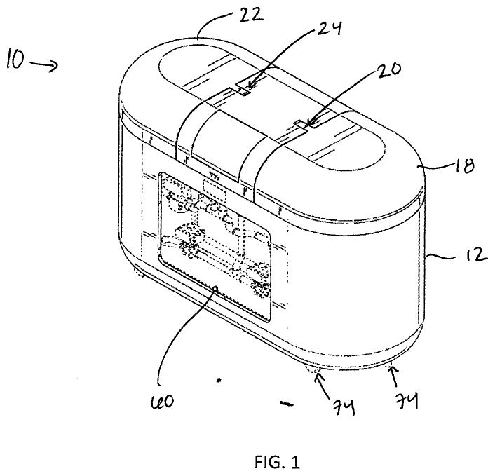

The present embodiment presents a brewing system 10 for use in brewing liquid, for example, for brewing beer. While described throughout as being used for brewing beer, various other liquids may be formed within the brewing system 10. FIG. 1 illustrates a top perspective view of the brewing system 10 which is defined by a generally rounded rectangular shape. More particularly, the brewing system 10 comprises an outer housing 12 that comprises a generally rectangular portion and at least two rounded portions arranged on either side of the rectangular portion. As will be described further herein, the rounded portions may be configured for housing several tanks within the outer housing 12.

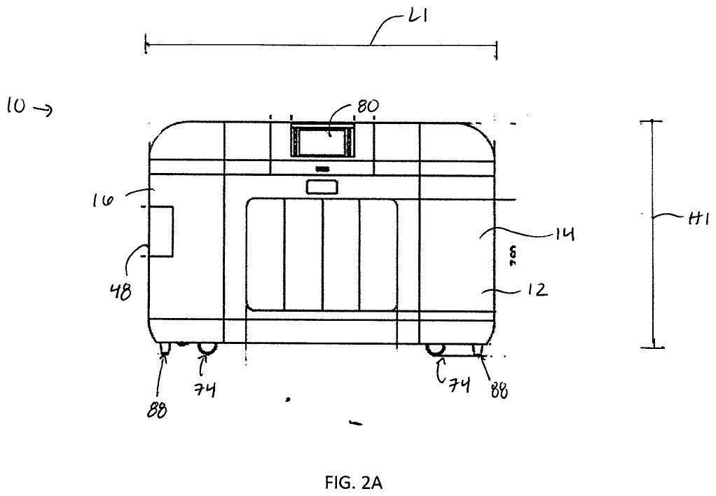

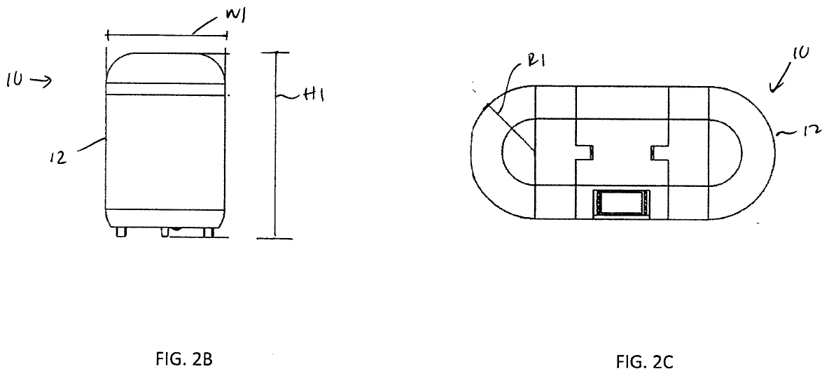

FIG. 2A illustrates a front facing schematic view of the brewing system 10. As illustrated best in FIG. 2A, the brewing system 10 has a length L1 of approximately 230 cm and a height of approximately 155 cm. The height may be defined as a total height of the brewing system 10 from the bottommost surface to a topmost surface. Additionally, as illustrated best in the side view of FIG. 2B, the brewing system 10 may have a width of approximately 100 cm. In embodiments, the length L1 may be approximately 7 feet, the width W1 may be approximately 2 feet, and the height H1 may be approximately 5 feet. As a result, the brewing system 10 may cover a ground or floor area of approximately 2.5 m₂. Further, as illustrated best in the top view of FIG. 2C, the rounded portions are defined by a radius R1, which may be approximately 50 cm. However, the values provided herein for the above-described dimensions of the brewing system 10 are provided as examples and other values may be incorporated. For example, the length L1, the width W1, the height H1 and the radius R1 may all vary depending on the size desires and/or constraints of the brewing system 10.

Further, as will be described further herein, the outer housing 12 may house a volume of liquid of approximately 30 L to 200 L. In other words, up to 200 L of beer may be brewed at a time within the brewing system 10. However, various other values of liquid may be supported within the brewing system 10 and the above values are provided for example. Additionally, the brewing system 10 may be composed of various materials, such as stainless steel and/or titanium. However, various other materials may be incorporated. The weight of the brewing system 10 may be approximately 600 kg to 840 kg. In further embodiments, depending on the materials used, the weight of the brewing system 10 may be less than or greater than the provided example range.

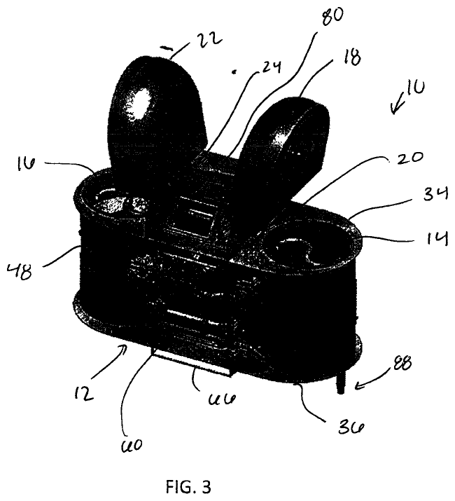

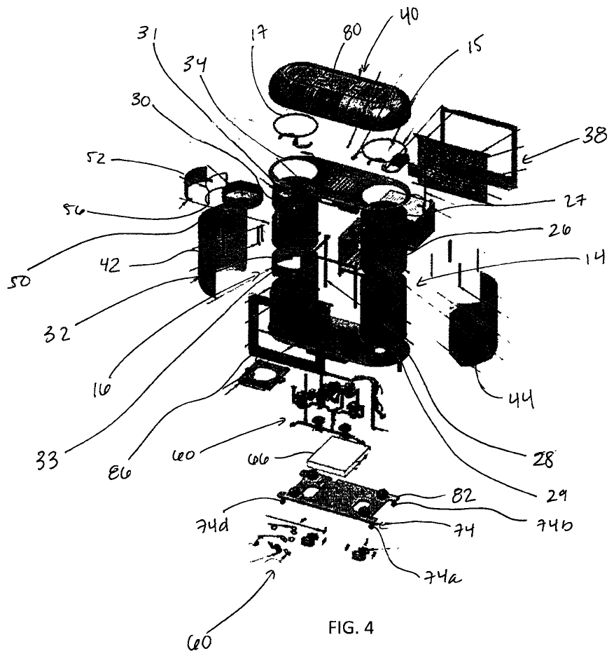

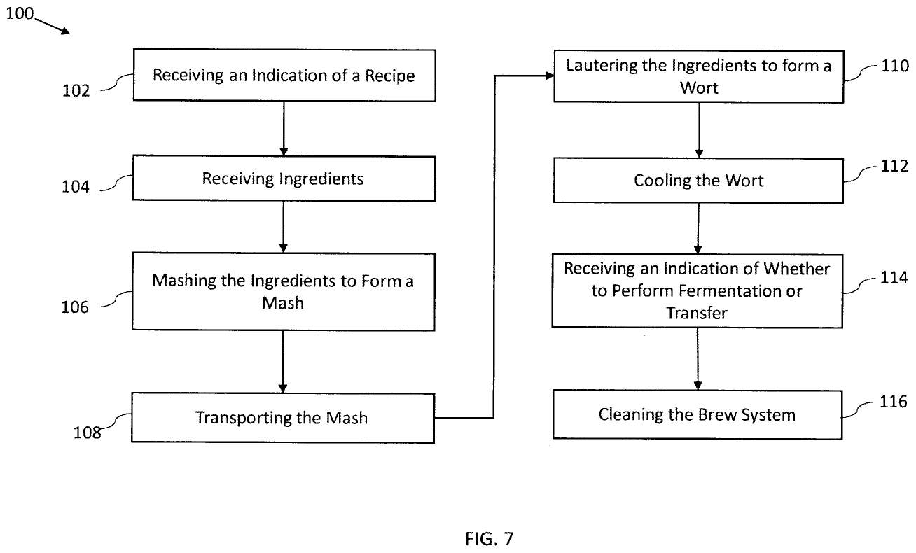

FIG. 3 illustrates a perspective view of the brewing system 10 and more particularly, various of the internal components of the brewing system 10. As illustrated, the brewing system 10 includes a first tank 14 positioned adjacent a second tank 16 within an interior region of the outer housing 12. The first tank 14 and the second tank 16 may be fluidly coupled through a fluid coupling system 60 positioned between the first tank 14 and the second tank 16. Further, each of the first and second tank 14, 16 may have a respective cover configured for reversibly covering the first and second tanks 14, 16. More particularly, the first tank 14 has a cover 18 having a hinged connection with the first tank 14. As illustrated best in FIGS. 1 and 3, the first tank 14 is coupled with the first tank 14 at a hinge assembly 20 such that the cover 18 may be hinged open from the configuration shown in FIG. 1 to the configuration shown in FIG. 3. The hinge assembly 20 may be manually actuated and/or automatically actuated through an operator interface, as will be described further herein. With reference still to FIGS. 1 and 3, the second tank 16 also includes a cover 22 arranged over the tank 16. Similar to the cover 18 of the first tank 14, the cover 22 is coupled with the second tank 16 through a hinge connection, namely a hinge assembly 24. In this way, the cover 22 may be manually and/or automatically actuated from the closed configuration of FIG. 1 to the open configuration illustrated in FIG. 3. As will be described further herein with reference to FIG. 7, the covers 18, 22 may be selectively opened when adding ingredients into the first and second tanks 14, 16 and/or when contents of the tanks 14, 16 are being boiled and vapor needs to be released from the first and second tanks 14, 16. Additionally, with reference to the exploded view of FIG. 4, each of the first and second tanks 14, 16 may comprise a sealing mechanism to ensure a fluid tight seal when the covers 18, 22 are in the closed configuration. For example, the first tank 14 works with a sealing ring 15 to form a fluid tight seal between the first tank 14 and the cover 18 and the second tank 16 works with a sealing ring 17 to form a fluid tight seal between the second tank 16 and the cover 22. In some embodiments, the first tank 14 may be referred to as the brew tank while the second tank 16 may be referred to as the lauter tank, the purposes for which will be described further herein.

With reference to the exploded view of FIG. 4, the components of the brewing system 10 will be described further herein. As illustrated, the first tank 14 may be composed of two separate tanks welded together such that the first tank 14 is defined by an inner cylinder 26 at least partially received within an outer cylinder 28. The inner cylinder 26 may have a volume of approximately 316 liters and may be defined by a cylinder wall 27 having a wall thickness of approximately 2 mm. The outer cylinder 28 may have a volume of approximately 304 liters and be defined by a cylinder wall 29 having a wall thickness of approximately 2 mm. In this way, the first tank 14 may have volume of approximately 240 L, such that the first tank 14 has a brew capacity of 200 L. Additionally, each of the inner cylinder 26 and the outer cylinder 28 may be composed of stainless steel.

In some embodiments, the second tank 16 may also be composed by an inner cylinder 30 and an outer cylinder 32 welded together. Similar to the first tank 14, the inner cylinder 30 may have a volume of approximately 316 liters and be defined by a cylinder wall 31 having a wall thickness of approximately 3 mm. The outer cylinder 32 may have a volume of approximately 304 liters and be defined by a cylinder wall 33 having a wall thickness of approximately 2 mm. In this way, the second tank 16 may have a total volume of 240 liters with a brew capacity of 200 liters. However, in other embodiments, the volume of the first tank 14 and/or the second tank 16 may vary.

With reference to the exploded view of FIG. 4, the brewing system 10, and more particularly the outer housing 12, includes a top panel 34 and a bottom plate 36 which may be positioned vertically above and vertically below the first and second tanks 14, 16, respectively. Additionally, the outer housing 12 includes a back door assembly 38 arranged behind the first tank 14 and the second tank 16 for enclosed a portion of the first and second tanks 14, 16 and an interior region defined by the outer housing 12. The back door assembly 38 may provide access to the components within the interior region of the outer housing 12 which may aid in servicing the brewing system 10. Additionally, the outer housing 12 include a front side assembly 86 which may be positioned opposite to the back door assembly 38. Further, the outer housing 12 of the brewing system 10 includes a top assembly 40 which may include the first and second covers 18, 22 of the first and second tanks 14, 16 along with an operator interface 80, as will be described further herein. Additionally, the outer housing 12 includes a left rounded panel 42 and a right rounded panel 44 for at least partially surrounding the first and second tanks 14, 16. Various of the panels, for example the top panel 34, the bottom plate 36, left rounded panel 42, and/or right rounded panel 44 may be welded with one another or with various other components of the outer housing 12 for forming the outer housing 12. In other embodiments, various other coupling mechanisms may be used for forming the outer housing 12. For example, fasteners may be used for coupling the various panels of the outer housing 12.

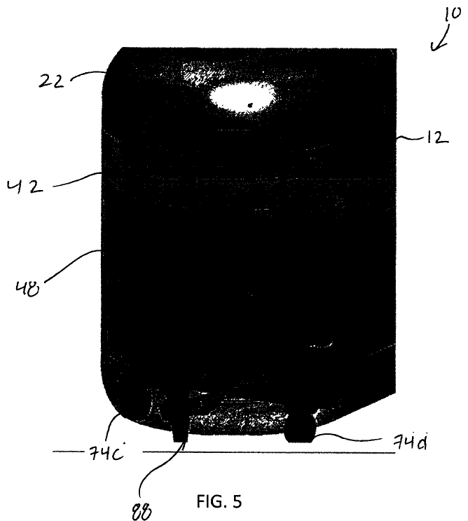

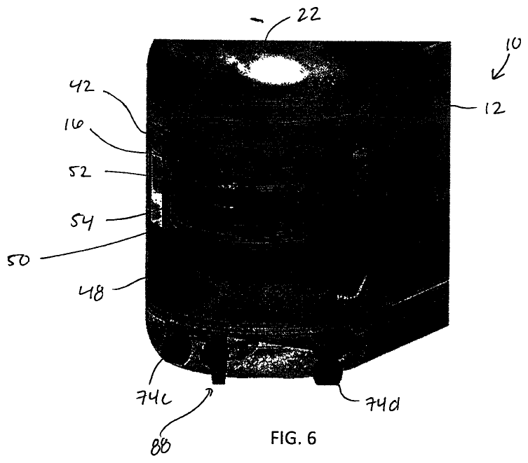

Further, with reference still the exploded view of FIG. 4 and the perspective view of a portion of the outer housing 12 shown in FIG. 5, the outer housing 12, and more specifically, the left rounded panel 42, comprises a window 48 which is arranged directly in front of a grid basket door of the second tank 16. For example, FIG. 6 illustrates the portion of the outer housing 12 with the window 48 in an open position. As illustrated, the second tank 16 includes a grid basket 50 arranged there within, the grid basket 50 having a grid basket door 52 comprising a handle 54 for actuation by a user. Additionally, in some embodiments and as illustrated in the exploded view of FIG. 4, the brewing system 10 may include a sealing ring 56 between the grid basket 50 and the grid basket door 52 to ensure a fluid tight seal between the second tank 16 and the surroundings while the brewing system 10 is being operated. The grid basket 50 may be configured to collecting mash formed within the second tank 16 which may then be removed and emptied by the user. For example, the grid basket door 52 may be actuated through use of the handle 54 to remove the grid basket 50 and dispose of any substance, such as the collected mash. After removal, the user can empty the grid basket 50 and place it back into the second tank 16 for continued collection of mash when the brewing process is repeated. This is particularly beneficial during the step of clarifying the wort during the brew process, as will be described further herein.

While examples of brewing system 10 are described as including grid basket 50 and various associated aspects (e.g., window 48, grid basket door 52, and sealing ring 56), it will be appreciated that, in other examples, such aspects may be omitted. For instance, in such an example, left rounded panel 42, inner cylinder 30, and outer cylinder 32 may each instead have a substantially continuous surface in place of grid basket 50 and the described associated aspects.

Further, with reference still to FIGS. 3 and 4, the brewing system 10 also includes a fluid coupling system 60, which may be arranged between and coupled with both the first tank 14 and the second tank 16. The fluid coupling system 60 comprises a plurality of components coupled with one another, for example valves, actuators, and pipes, that may interact to allow for transporting fluid throughout the brewing system 10 depending on which portion of the process is presently conducted. Additionally, the brewing system 10 also includes a waste-water tank 66 positioned vertically below and fluidly coupled with the fluid coupling system 60. The waste-water tank 66 is configured for receiving the waste throughout the process of brewing and cleaning the brewing system 10 once the brewing process is complete. In some embodiments, the waste-water tank 66 has a volume of approximately 55 liters. However, various other sizes may be incorporated. It will further be appreciated that, in other examples, waste-water tank 66 may be omitted, such that waste-water is alternatively, or additionally, expelled through a pipe or other mechanism accordingly.

Further, with reference still to FIG. 4, the brewing system 10 may additionally include a chiller 68 arranged adjacent the fluid coupling system 60 and between the first tank 14 and the second tank 16. The brewing system 10 may further include a chiller frame assembly 70 for supporting the chiller 68 while arranged within the outer housing 12 of the brewing system 10. In some embodiments, the chiller 68 is a glycol chiller, however, various other types of chillers may be incorporated. The chiller 68 may be used throughout the process of brewing to pre-cool one or both of the first and second tanks 14, 16, and/or chill the fluid while arranged within one or both of the first and second tanks 14, 16, as will be described further herein with reference to FIG. 7.

Additionally, as illustrated in FIGS. 1-2, the brewing system 10 may have a plurality of wheels 74 attached to a bottom of the outer housing 12, and more particularly to a base plate 84, to allow for easier transport of the brewing system 10. Illustratively, the plurality of wheels 74 includes a first wheel 74a, a second wheel 74b, a third wheel 74c and a fourth wheel 74d. For example, the brewing system 10 may be wheeled in and out of buildings and rooms. This ease in portability and the smaller size of the brewing system 10, as opposed to that of typical beer brewing systems, allows for an easy and a quick installation process. For example, the installation may be completed in less than ninety minutes. Additionally, the brewing system 10 may have a plurality of posts 88 extending from the bottom of the outer housing 12 to stabilize the positioning of the brewing system 10 once installed. The installation process includes wherein the operator determines the location for the brewing system 10, the brewing system 10 is delivered, water supply is attached to the brewing system 10, and electrical supply is attached to the brewing system 10 to allow for operation of the brewing system 10. Once these various attachments are completed, the brewing system 10 is prepared and operational. While the brewing system 10 may be mainly powered by the connected with the electrical supply, the brewing system 10 may have an eight-hour battery back-up system on board.

With reference again to FIGS. 1-4, the brewing system 10 and more particularly the outer housing 12, includes the operator interface 80 arranged thereon. The operator interface 80 is configured for controlling the operation of the brewing system 10 and allowing for each step of the brewing process to be automated. An operator is able to actuate the operator interface 80 to control which type of beer is brewed as well as to monitor the brewing process. In this way, the users can identify which beer they would like to brew and are able to step away and multitask while not focusing only the brewing system 10. However, in various embodiments, it is still possible for the operator to be manually involved in some of the steps of the process to retain any customizations of the process that the operator may desire.

This operator interface 80 may be controlled in several ways. For example, the operator interface 80 may have a touch screen interface so the operator may provide direct input into the device. In further embodiments, the operator interface may be wirelessly controlled through a remote control and/or an application on a mobile device so a user can remotely control the operation of the brewing system 10. The operator interface 80, via a touch screen or via the wireless access, may be used to turn on, turn off, monitor, change parameters or functions of, and/or complete the brewing process. In this way, minimal manual labor is required by the operator or other team members. The operator interface 80 and the brewing system 10 are also interconnected with various software systems and processes that allow for the brewing system 10 to be connected with the internet and wireless networks.

To control the above-described processes, the operator interface 80 may include the touch screen enabled control panel, also referred to as the display or the screen, for direct input by the operator. In operation, when the operator would like to go through the process of brewing beer or accomplish various other action items of the brewing system, various displays on the operator interface 80 may walk the operator through these steps. For example, when the operator activates and powers up the brewing system 10, the screen of the outer housing 12 may light up to accept input. First, upon start of the brewing system 10, the screen may indicate that the device is powered on. The screen may then display a loading display to indicate that device is connecting with the internet and network. Next, the control panel may display several action buttons for actuation by the operator to select a process to be commenced. For example, the action buttons may include a “brew button” for initiating a brewing process, an “order button” for ordering ingredients or accessories (e.g., as a one-time operation or according to a schedule or subscription), a “learn button” for watching tutorials on how to use the device and/or accessories of the device, and a “system button” which may provide access to the operator to review the system status and details.

Upon selection of any of the action buttons, a message may be pushed via the network to be conveyed to the operator. For example, upon selecting the “brew button” for the first time, a message may be pushed to the customer welcoming them to a first use of the brew process. The message that is pushed to the operator may be sourced from a large database of messages and/or push notifications that may be helpful to the operator.

The operator may use the “brew button” and several subsequent steps in order to commence brewing of the desired beer. For example, the operator may actuate the “brew” action button which may launch a window with one or more selectable recipes (e.g., from a library of recipes) for brewing the liquid. Once the recipe is chosen, the operator may select the capacity of beer that is desired for brewing. After actuation of a start button, for example a “Let's Brew” button, the brewing system 10 begins the brew process according to the selected beer recipe. Throughout the brewing process, the operator may be notified by a sound or by a text message, or any other applicable notification mechanism, to indicate when intervention by the operator is required. Additionally, the control display may indicate the status or the step of the brewing process such that an operator is able to check on the system at any point and be informed of the status of the brew. After brewing is complete, the operator may decide to ferment the liquid within the brewing system 10 itself, or the liquid may be transferred to another tank or system for fermentation. For example, after brewing, the control display may provide selectable options for continuing fermentation within brewing system 10 or for transferring the brewed liquid into another tank or system for fermentation. After transferring the liquid, if desired, the operator may use the operator interface 80 to begin another brewing process.

Beyond allowing for the operator to start and monitor the process, the operator may be informed of any errors that occur during the brewing process. For example, errors or pauses in production of the beer may be indicated to the operator through an alert. More specifically, errors such as no water flow, low heat, blocked water jets, failure to transfer the liquid through the outer housing 12 and/or any other applicable errors during processing, may be reported to the operator with a specific description of what has gone wrong. Further, the brewing system 10 may be programmed to additionally provide suggestions to the operator on how to fix the problem and continue the brewing process. These alerts may be delivered to the operator through the operator interface 80 provided on the device or to a remote device of the operator. For example, if the operator has programmed a remote device such as a mobile device to be used with the brewing system 10, the operator may receive these status and error updates to the remote device.

Further, the software processing of the brewing system 10 may connect with a customer portal such that all the information relating to the individual brewing system 10 and any associated systems used with the brewing system 10 can easily be accessed from the operator. The software system and compatibility with the brewing system 10 additionally allows for continuous and efficient customer support that can be accessed by an operator at any time. For example, a website may have a customer portal having an operator interface including training videos, troubleshooting options, community contacts, as well as contact links for understanding and addressing any issues that arise. Additionally, each brewing system 10 may have the ability to wired or wirelessly connect with the internet to access an operating center that provides support for the operator. The software system may transmit the system performance and data history to this operating center so that the issues can be reviewed thoroughly and specifically for each individual device, resulting in accurate and efficient operator support. Various other systems may be incorporated to provide efficient and easily accessible customer support.

With reference now to the flow chart of FIG. 7 and the components of FIGS. 1-6, a method 100 of brewing a liquid, and more particularly beer, will be described herein. While described with reference to the process of making beer, the process may be modified and/or applied to brewing various other liquids. Further, any of the below steps may be actuated by the operator interface 80 and/or the software as briefly described above.

At block 102, the method 100 first includes receiving, by the brewing system 10, an indication of a recipe via the operator interface 80. The recipe may provide the user with the ingredient requirements for brewing the beer. The method 100 further includes the step of receiving ingredients at block 104. During this step, the user may deliver the required amount and type of grains and/or other ingredients into the first tank 14. Additionally, water may be delivered into the first tank 14. For example, in some examples, between approximately 140 liters and 160 liters of water may be delivered into the first tank 14. The delivery of ingredients into the first tank 14 may be done automatically, manually, and/or a combination of both. For example, the grains may be inserted manually into the first tank 14 by the user while the water may be delivered into the first tank 14 automatically through connections with the fluid coupling system 60.

Further, the method 100 may further include the step at block 106 which includes mashing the ingredients to form a mash. During this step, the water may be boiled within the first tank 14 until reaching a predetermined temperature. Further, malt may then be added into the first tank 14 and poured into the first tank 14 when the cover 18 of the first tank is open. After the incorporation of the malt, the first tank 14 is actuated for mashing of the malt to form a mash.

At block 108, the method 100 then includes transporting the mash from the first tank 14 to the second tank 16. During this step, the fluid coupling system 60 is actuated such that the mash and any remaining fluid within the first tank 14 is pumped into the second tank 16 and the first tank 14 is completely emptied.

Further, at block 110, the method 100 further includes lautering the ingredients to form a wort within the second tank 16. During this step, the lautering of the ingredients forms a wort and a residual grain. This step includes filtering the mash that was transporting from the first tank 14 into the second tank 16 and filtering this mash through the grid basket 50, which is arranged within a center portion of the second tank 16 as previously described. The residual grain is the material that is captured on the grid basket 50 after being filtered through, which may also be referred to herein as the mash cake. Further, the material from the mash that filters through the grid basket (i.e., below the grid basket 50), is considered the wort, or the clarified wort. The residual grain is composed of the sugar content of the mash with the intent to clear the sugar content form the mash such that the wort is largely clear of the sugar content. Additionally, through actuation of the fluid coupling system 60, the wort that extends through the grid basket 50 may be repeatedly removed from the second tank 16 and reintroduced into the second tank 16 for passage through the grid basket 50 and continued filtering of the wort.

After the completion of the wort filtration, the method 100 may then include the step illustrated at block 112, which includes cooling the wort. In some embodiments, prior to cooling of the wort, the wort is transported from the second tank 16 to the first tank 14 so that the second tank 16 may be pre-chilled with the wort being disposed therein. For example, this may be done through activating the chiller 68 and delivering cold fluids between the inner cylinder 30 and the outer cylinder 32 of the second tank 16 to pre-chill the second tank 16. This fluid may be delivered due to actuation of the fluid coupling system 60. In some embodiments, the second tank 16 may be cooled to a temperature of approximately seven degrees Celsius. Once the second tank 16 is sufficiently pre-chilled, the wort may then be transferred back into the second tank 16 for cooling of the wort. For example, in some embodiments, the wort may sit within the second tank 16 for approximately an hour and a half until the wort is cooled. However, in various other embodiments, the time for chilling the wort may vary.

At block 114, the method 100 then includes receiving an indication of whether to perform fermentation of the wort within the second tank 16 of the brewing system 10 or if the wort should be transferred to a separate system for fermentation. In the embodiments wherein the indication is provided to perform fermentation of the wort within the brewing system 10, the brewing system 10, including the fluid coupling system 60, may be actuated for starting an automatic lautering process within the brewing system 10. In the embodiments wherein the indication is provided for transferring the wort out of the brewing system 10 to a separate system, such as a tank configured for fermentation.

As illustrated in FIG. 7, the method 100 may further include the step at block 116 which includes cleaning the brewing system 10. For example, once the second tank 16 of the brewing system 10 is completely empty, a self-cleaning system may be actuated and clean the entirety of the brewing system 10. In this way, the first tank 14, the second tank 16, and the spacing within the outer housing 12 and may be cleaned automatically without user intervention required. In some embodiments, this step of cleaning the brewing system 10 may take approximately eight hours. Even further, in some embodiments, the method 100 further includes providing a notification to the user through the operator interface 80 of the brewing system 10. Further, as previously described, any of the above steps within the method 100 may be performed automatically by the software of the brewing system 10.

The above-described systems provide several advantages and benefits over the standard equipment that is currently used for brewing beer. While the benefits herein are described largely with reference to the brewing system 10, the benefits may apply to the use of the various other systems described herein such as the distilling system, modified brewing system, milling system, and fermenting system. Among various other advantages, due to the portability of the brewing system, the ease of installation and the streamlined system and processes, the brewing system 10 described herein may reduce the equipment required and installation costs by at least 50%. Additionally, as previously described, the brewing system may allow for the brewing process to run without constant input or supervision from the operator, as well as enabling novice operators to brew beer. In this way, the brewing system 10 may reduce labor costs by using existing venue staff without requiring additional skilled staff to monitor the device. The size of the brewing system 10 is compact and as such can occupy smaller footprints without sacrificing seating capacity and attendant revenue generation in restaurants, breweries, or other establishments. Moreover, the brewing system 10 can be installed in residential sites. Further, while a fermenting system may optionally be used in combination with the brewing system, it is not required, and the entire process may be completed within the brewing system. Yet another advantage of the above-described system is that the previously described self-cleaning system allows for maintaining cleanliness of the system while reducing the manual labor and time needed for cleaning a typical brewing system. Additionally, another advantage is the timing of the process itself. For example, the steps from block 102 to block 112, including the cooling of the wort within the second tank 16, may be conducted within a maximum of four and a half hours.

The following clauses are provided as example aspects of the disclosed subject matter:

1. A brewing system, including: an outer housing; a first tank and a second tank arranged within an interior region of the outer housing, the first tank defined by an inner cylinder and an outer cylinder, and the second tank defined by an inner cylinder and an outer cylinder; a fluid coupling system arranged between the first tank and the second tank and fluidly coupling the first tank and the second tank; and an operator interface for controlling the operation of the brewing system.

2. The brewing system of clause 1, wherein the operator interface is positioned on the outer housing and arranged laterally between the first tank and the second tank.

3. The brewing system of clause 1, wherein the length of the outer housing is approximately 7 feet and the height of the outer housing is approximately 5 feet.

4. The brewing system of clause 1, wherein the brewing system has a volumetric capacity of between approximately 30 L and approximately 200 L.

5. The brewing system of clause 1, wherein the brewing system includes a first cover reversibly coupled with the first tank and a second cover reversible coupled with the second tank.

6. The brewing system of clause 5, wherein the first cover is coupled with the first tank through a hinge assembly, and the second cover is coupled with the second tank through a hinge assembly.

7. The brewing system of clause 1, wherein the outer housing comprises a plurality of wheels extending from a bottom surface of the outer housing allowing for transport of the brewing system.

8. The brewing system of clause 1, wherein the outer housing is composed of stainless steel.

9. The brewing system of clause 1, wherein the second tank comprises a grid basket arranged therein, and a grid basket door disposed within the second tank.

10. The brewing system of clause 9, wherein the grid basket door may be actuated by a user to remove the grid basket for emptying of the grid basket.

11. The brewing system of clause 9, wherein the outer housing comprises a window aligned with the grid basket door for providing access to the grid basket door.

12. The brewing system of clause 1, wherein the brewing system further includes a chiller arranged adjacent the fluid coupling system.

13. A method of brewing a beverage using a brewing system, wherein the brewing system includes a first tank positioned adjacent to and fluidly coupled with a second tank, the method including: receiving, by the brewing system, an indication of a recipe via an operator interface; receiving ingredients; mashing the ingredients to form a mash; transporting the mash; lautering the ingredients to form a wort; cooling the wort; receiving an indication of whether to perform a fermentation of the wort or a transfer of the wort to a separate system; and cleaning the brew system.

14. The method of clause 13, further comprising: performing the mashing and the lautering steps automatically.

15. The method of clause 13, further comprising: receiving an indication to ferment the wort; and automatically initiating a fermentation cycle of lautered contents of the brewing system.

16. The method of clause 13, further comprising: providing a notification when the steps of the method have been completed.

17. The method of clause 13, wherein the mashing step occurs in the first tank of the brewing system and the lautering occurs in the second tank of the brewing system.

18. The method of clause 13, wherein the step of transporting the mash includes transporting the mash from the first tank to the second tank.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided the description and illustration of the present application, one skilled in art may envision variations, modifications, and alternate aspects falling within the spirit of the broader aspects of the general inventive concept embodied in this application that do not depart from the broader scope of the claimed disclosure.

What is claimed is:

1. A brewing system, including:
an outer housing;
a first tank and a second tank arranged within an interior region of the outer housing, the first tank defined by an inner cylinder and an outer cylinder, and the second tank defined by an inner cylinder and an outer cylinder;
a fluid coupling system arranged between the first tank and the second tank and fluidly coupling the first tank and the second tank; and
an operator interface for controlling the operation of the brewing system.

2. The brewing system of claim 1, wherein the operator interface is positioned on the outer housing and arranged laterally between the first tank and the second tank.

3. The brewing system of claim 1, wherein the length of the outer housing is approximately 7 feet and the height of the outer housing is approximately 5 feet.

4. The brewing system of claim 1, wherein the brewing system has a volumetric capacity of between approximately 30 L and approximately 200 L.

5. The brewing system of claim 1, wherein the brewing system includes a first cover reversibly coupled with the first tank and a second cover reversible coupled with the second tank.

6. The brewing system of claim 5, wherein the first cover is coupled with the first tank through a hinge assembly, and the second cover is coupled with the second tank through a hinge assembly.

7. The brewing system of claim 1, wherein the outer housing comprises a plurality of wheels extending from a bottom surface of the outer housing allowing for transport of the brewing system.

8. The brewing system of claim 1, wherein the outer housing is composed of stainless steel.

9. The brewing system of claim 1, wherein the second tank comprises a grid basket arranged therein, and a grid basket door disposed within the second tank.

10. The brewing system of claim 9, wherein the grid basket door may be actuated by a user to remove the grid basket for emptying of the grid basket.

11. The brewing system of claim 9, wherein the outer housing comprises a window aligned with the grid basket door for providing access to the grid basket door.

12. The brewing system of claim 1, wherein the brewing system further includes a chiller arranged adjacent the fluid coupling system.

13. A method of brewing a beverage using a brewing system, wherein the brewing system includes a first tank positioned adjacent to and fluidly coupled with a second tank, the method including:
receiving, by the brewing system, an indication of a recipe via an operator interface;
receiving ingredients;
mashing the ingredients to form a mash;
transporting the mash;
lautering the ingredients to form a wort;
cooling the wort;
receiving an indication of whether to perform a fermentation of the wort or a transfer of the wort to a separate system; and
cleaning the brew system.

14. The method of claim 13, further comprising:
performing the mashing and the lautering steps automatically.

15. The method of claim 13, further comprising:
receiving an indication to ferment the wort; and
automatically initiating a fermentation cycle of lautered contents of the brewing system.

16. The method of claim 13, further comprising:
providing a notification when the steps of the method have been completed.

17. The method of claim 13, wherein the mashing step occurs in the first tank of the brewing system and the lautering occurs in the second tank of the brewing system.

18. The method of claim 13, wherein the step of transporting the mash includes transporting the mash from the first tank to the second tank.
